(19) United States
(12) Patent Application Publication
(10) Pub. No.: US 2008/0250124 A1
(43) Pub. Date: Oct. 9, 2008

(54) REDUNDANCY-PROTOCOL CONFIGURATION IN A RING NETWORK

(75) Inventors: Markus RENTSCHLER, Dettingen (DE); Werner MAISCH, Neuffen (DE)

Correspondence Address: K.F. ROSS P.C., 5683 RIVERDALE AVENUE, SUITE 203 BOX 900, BRONX, NY, 10471-0900, US

(73) Assignee: Hirschmann Automation and Control GmbH

(21) Appl. No.: 12/098,476

(22) Filed: Apr. 7, 2008

(30) Foreign Application Priority Data
Apr. 5, 2007 (DE) 102007016432.9

(51) Int. Cl. G06F 15/16

(52) U.S. Cl. 709/220

(57) ABSTRACT

In a network having a plurality of nodes each with at least two ports and lines or links connecting the ports in a ring. The improvement wherein one of the nodes is configured as a ring manager capable of configuring the other nodes via the links. Thus starting from a node used as ring manager the redundancy protocol of the other nodes is automatically configured via the lines by means of data packets containing the configuration data, which data packets are sent out via the lines by the ring manager.

### FIELD OF THE INVENTION

The present invention relates to a ring network. More particularly this invention concerns a method of configuring a redundancy protocol in nodes in a redundant ring network.

### BACKGROUND OF THE INVENTION

An ethernet network is described in U.S. Pat. No. 6,430,151 that is set up as a ring network. Nodes are arranged in this ring network that are connected to each other by links (connecting lines) and each node comprises at least two interfaces at which the lines are connected.

The nodes, which are constructed as layer two nodes, can be switching systems (ethernet switches), automation systems, service- and/or observation stations, servers, printers, other networks and the like. These nodes are arranged in particular when used in automation technology at distances that can frequently be very large, even several kilometers.

The problem arises when setting up a new installation as well for later changes, that a configuration of the nodes in the ring network is necessary. Such a configuration can be a first setup configuration but can also just as well be an update of a node that had already been configured. In known processes for configuring nodes in a ring network it is therefore necessary that an IT technician go to each node and configure it on site. He or she connects, for example, a laptop to the node and runs configuration software. Such a configuration process cannot be carried out quickly, and is quite expensive because of the time and travel involved in traveling to the various nodes in the ring network.

### OBJECTS OF THE INVENTION

It is therefore an object of the present invention to provide an improved configuration system and method for a ring network.

Another object is the provision of such an improved configuration system and method for a ring network that overcomes the above-given disadvantages, in particular that shortens the time for a configuration of the redundancy protocol in nodes in the ring network.

### SUMMARY OF THE INVENTION

In a network having a plurality of nodes each with at least two ports and links connecting the ports in a ring. The improvement wherein one of the nodes is configured as a ring manager capable of configuring the other nodes via the links.

Thus with the ring network in accordance with the invention at least one node is designed as a ring manager in such a manner that the other nodes are configured via the link lines by this ring manager.

According to the process for configuring the redundancy protocol of the nodes that starting from a node used as ring manager the redundancy protocol of the other nodes is automatically configured via the lines by means of data packets containing the configuration data, which data packets are sent out via the lines by the ring manager.

The process for configuring the redundancy protocol of the nodes and the correspondingly designed ring network thus have the advantage that the configuration of the redundancy profile of nodes in the ring network can be carried out centrally from one location without a service technician having to make the configuration on site at each individual node. This makes it possible to configure such a ring network significantly faster. Thus, starting from a network node (the ring manager), a physically present, closed, ring-shaped path is automatically detected in a connected topology of the ring network. To do this, the controlling ring manager sends data packets containing the configuration data out to the interfaces (ports) via which the topology to be considered is connected, which configuration data is forwarded by the connected, subordinate nodes (such as ring clients, other network nodes and the like) at all their ports. The receiving ports of these packets are identified by the participating ring clients as ring ports. Those clients that received the data packets with the configuration data of a ring manager at two ports are thus directly in the topology of a ring or loop of the ring network and forward the received packets of the ring protocol only out via their other ring port, so the packets move around the ring. Thus, the participating nodes in the ring network are used for automatic and self-executing configuration, starting from the ring manager. The ports of the nodes in the ring network no longer have to be manually configured in an expensive manner due to the process in accordance with the invention but can automatically configure themselves. This produces significant advantages, especially with respect to costs, in the configuration of a ring topology.

Due to the administration of the information in the nodes of each port and ring manager, the process is also suitable for configuring multiple looped rings. A prerequisite for this is that an unambiguous ring manager is present in each loop. In accordance with its design, a ring manager can administer multiple ring structures.

As long as a detected ring is closed and the data packets with the configuration data are received from both directions the ring manager blocks at least one of its ring ports for normal data traffic. If the reception of configuration data does not occur, it automatically also opens the port for the data traffic of the that had been closed up to that point.

### BRIEF DESCRIPTION OF THE DRAWING

The above and other objects, features, and advantages will become more readily apparent from the following description, reference being made to the accompanying drawing in which:

FIG. 1 is a schematic diagram of the network according to the invention; and

FIG. 2 is a schematic diagram of another network in accordance with the invention.

### SPECIFIC DESCRIPTION

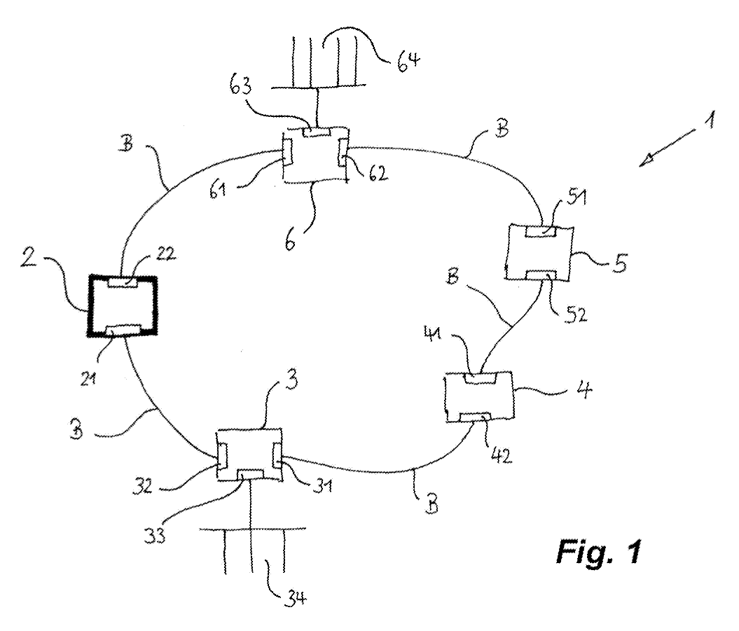

As seen in FIG. 1 a ring network consists of only one ring (=one loop). Several nodes 2 to 6 are arranged in a ring network 1 and connected to each other via link lines B. The individual nodes 2 to 6 each include at least two respective interfaces or ports 21, 22, 31, 32, 33, 41, 42, 43, 51, 52, 61, 62, and 63. This means that a node either has two ports and is therefore arranged only in this one ring of the ring network or has more than two interfaces, in which case extending networks 34, 64 can be connected but do not have to be connected to the other interface 33, 63.

In this ring network 1 one of the nodes, here node 2, is designed as a ring manager. That means that after the ring network 1 has been set up, an operator (such as an IT service technician, system administrator or the like) selects this node as ring manager and use it to configure the redundancy protocol of the other nodes 3 to 6 arranged in the ring network 1 or allows them to be configured automatically by a protocol bot without actually working on these nodes.

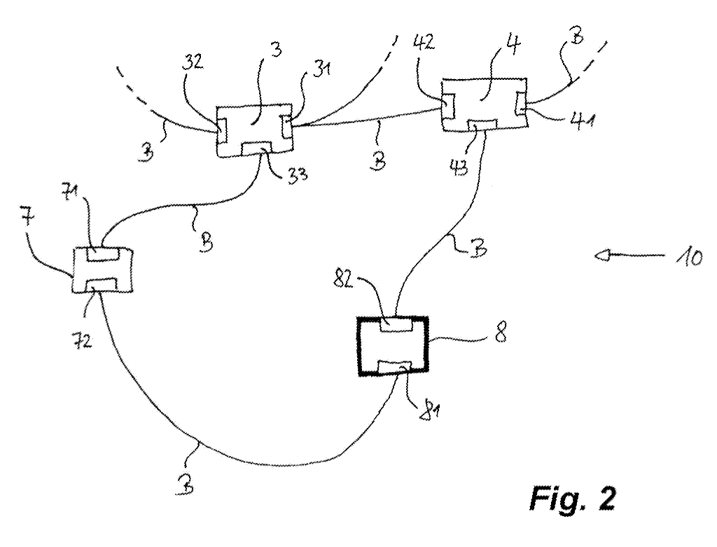

It is therefore possible for this ring manager 2 to configure the redundancy protocol of all the other nodes 3 to 6 (or even more) in the ring network 1 from a central location without having to physically go to these other nodes 3 to 6. This is particularly advantageous in administering large networks in which the individual nodes 3 to 6 are frequently at a considerable remove from one another.

Whereas FIG. 1 shows that the ring network 1 is a single-loop ring network, FIG. 2 shows a ring network 10 having more than one loop. For the sake of simplicity a single second loop is shown, and the configuring process can also be used in networks containing more than two loops or rings. Here further links are connected to interfaces 33, 43 of nodes 3, 4, which links connect nodes 3 and 4 to other nodes 7 and 8. Even these nodes 7 and 8 each have at least two respective interfaces 71, 72 and 81, 82. Just as in the one-loop ring network 1 according to FIG. 1, one of the nodes, here node 8, is designed as a ring manager in the multi-loop ring network 10 according to FIG. 2 in addition to ring manager 2 (FIG. 1).

Finally, an especially essential point for the invention can be seen in the fact that the participating nodes (here with the reference numerals 2 to 6 in a simple ring network or 2 to 8 in a multiloop ring network) can be used in networks over great distances that can also amount to several kilometers or even more. Thus, the process in accordance with the invention offers a configuration of the redundancy profile of the nodes in a ring network centrally from one location, namely, the ring manager. Thus, it is no longer necessary that the person whose job it is to configure the nodes has to go physically to each node in order to configure it.

We claim:

1. In a network having a plurality of nodes each with at least two ports and links connecting the ports in a ring, the improvement wherein one of the nodes is configured as a ring manager capable of configuring the other nodes via the links.

2. The ring network defined in claim 1 wherein the ring manager can send out over the links data packets capable of configuring the ports of the other nodes.

3. The ring network defined in claim 1 wherein there is only one ring manager in the network.

4. The ring network defined in claim 1, further comprising
a second ring network including a plurality of second nodes each with two respective ports and second links connecting the ports of the second nodes in a ring, one of the other nodes of the first-mentioned ring network having interfaces connected to links of the second network, the ring manager being capable of configuring the second nodes via the one other node.

5. The ring network defined in claim 1 wherein one of the nodes is configured as a redundancy manager.

6. The ring network defined in claim 1 wherein the links are hard-wired.

7. A method of configuring nodes connected in a network wherein each of the nodes has at least two interfaces and links connect the nodes in a ring, the method comprising establishing one of the nodes as a ring manager and using it to send data packets via the links to the other nodes and configure the other nodes with the data packets.

8. The method defined in claim 7 wherein each of the other nodes uses the data packets from the ring manager to configure itself and any other nodes connected to itself.

9. The method defined in claim 7 wherein the data packets are circulated on the links through the nodes until all the other nodes are configured.
